(19) United States
(12) Patent Application Publication
(10) Pub. No.: US 2007/0178881 A1
(43) Pub. Date: Aug. 2, 2007

(54) Remotely controlling access to subscriber data over a wireless network for a mobile device

(76) Inventors: Harold W. A. Teunissen, Deventer (NL); Ko Lagerberg, Hengelo (NL); Miroslav Zivkovic, Enschede (NL); Jacco Brok, Enschede (NL)

Correspondence Address: WILLIAMS, MORGAN & AMERSON, 10333 RICHMOND, SUITE 1100, HOUSTON, TX, 77042, US

(21) Appl. No.: 11/343,732

(22) Filed: Jan. 31, 2006

(51) Int. Cl. H04M 3/16

(52) U.S. Cl. 455/410

(57) ABSTRACT

A method and apparatus for using messaging to remotely control access over a network to a subscriber data associated with a mobile device that may be stolen or lost is provided. The method of wireless communication over a network with a mobile device having access to data associated with a subscriber comprises transmitting at least one message to the mobile device over the network for instructing the mobile device to deny access to the data for an unintended use in response to an indication of connectivity to the network for the subscriber. Instead of blocking connectivity of a mobile device which may be stolen or lost to a network, by denying access to data available on a mobile device which may be stolen or lost, at least a portion such vulnerable data stored on the mobile device also becomes inaccessible for malicious usage.

### BACKGROUND OF THE INVENTION

1. Field of the Invention

This invention relates generally to telecommunications, and, more particularly, to messaging.

2. Description of the Related Art

Many communication systems provide different types of services to users of wireless or mobile devices. In a particular mobile service, wireless communication or data network may enable mobile device users to exchange peer-to-peer and/or client-to-server messages, which may be simply text messages or include multi-media content, such as data and/or video. This exchange of messages involves establishment of a connection between a source device through a number of network routers that incrementally advance a message towards its destination to a target device.

For example, on a wide area network (WAN), a network address may identify a particular node (e.g., an access point). By examining a destination network address of a message, network routers forward the message along a path from the message's source to the message's destination. The WAN may include a wireless local area network (WLAN) that provides access to users at hotspots. For such access, a user may sign up via a Web browser, pay on-demand and/or be billed against an existing provider account. To securely transmit and/or receive messages over a wired or wireless LAN, user credentials may be exchanged before data transfer over a wireless connection. However, such data associated with messages may not be secure for users, concerned about identity theft and security, if the mobile device is stolen or lost.

Often, regardless of a type of a network employed, before granting an access to a user of a mobile device to a wireless network, the user is typically authenticated. For example, most deployed WAN require a user to authenticate by typing a user name and a password on a web page (“web-based login”). Other wireless networks authenticate a user based on an authentication process. In some authentication implementations no user interaction such as a user name and a password are transmitted since such authentication may be vulnerable to password hijacking. For example, Hyper Text Transfer Protocols connections are vulnerable to man-in-the-middle attacks or an attacker could pose as a valid access point and thus obtain the credentials.

However, authentication about identity theft and security may be futile for users of a mobile device that is stolen or lost. Many mobile telecommunication systems aim to prevent network connectivity of the lost or stolen mobile device. A mobile network operator may block a specific network subscription of the lost or stolen mobile device to have access to the network. However, the data stored on the mobile device is still accessible and can be used for malicious practices.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of one or more of the problems set forth above.

In one embodiment of the instant invention, a method of wireless communication over a network with a mobile device having access to data associated with a subscriber is provided. The method comprises transmitting at least one message to the mobile device over the network for instructing the mobile device to deny access to the data for an unintended use in response to an indication of connectivity to the network for the subscriber.

In yet another embodiment of the instant invention, a communications system is provided in which a message service provider uses a messaging service engine for wireless communication over a network with a mobile device having access to data associated with a subscriber. The communications system comprises a receiver to receive an indication of connectivity to the network for the subscriber associated with the mobile device, a messaging service engine coupled to the receiver to provide at least one message for the mobile device to instruct the mobile device to deny access to the data associated with the subscriber for an unintended use in response to the indication of connectivity, and a transmitter coupled to the messaging service engine to send the at least one message to the mobile device over the network.

In further embodiment of the instant invention, a mobile device is provided. The mobile device comprises a receiver to receive at least one message over a network. The mobile device further comprises a controller coupled to the receiver for instructing the mobile device to deny access to data associated with a subscriber for an unintended use in response to an indication of connectivity to the network for the subscriber.

In another embodiment of the instant invention, a messaging service engine is provided. The messaging service engine comprises a controller adapted to transmit at least one message to a mobile device over a network to instruct the mobile device to deny access to data associated with a subscriber for an unintended use in response to an indication of connectivity to the network for the subscriber.

In still another embodiment of the instant invention, a method of wireless communication over a network is provided for a mobile device having access to data associated with a subscriber receiving at least one message at the mobile device over the network to instruct the mobile device to deny access to the data associated with the subscriber for an unintended use in response to an indication of connectivity to the network for the subscriber.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a communications system in which access to data associated with a subscriber of a mobile device may be remotely controlling over a network by a messaging service engine, in accordance with one embodiment of the present invention;

FIG. 2 depicts a stylized representation for implementing a method of providing instruction(s) to the mobile device shown in FIG. 1 to deny access to the data stored therein, according to one embodiment of the present invention; and

FIG. 3 depicts a stylized representation for implementing a method of using a messaging service over the network to send instruction(s) to the mobile device shown in FIG. 1 to selectively retrieve data before irrecoverably deleting the data stored therein, according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, a method and apparatus are provided for a wireless communication between a mobile device and a message service provider over a network in a communications system. The method comprises transmitting at least one message to a mobile device having access to data associated with a subscriber over a network the message(s) may instruct the mobile device to deny access to data that may be accessible for an unintended use. For example, a message service provider may receive an indication of connectivity to the network for a subscriber of the mobile device. In response to the indication of connectivity, a messaging service engine may transmit one or more messages to the mobile device over the network. In this way, a mobile device (for example, a General Packet Radio Service (GPRS)-enabled device), when provides an indication or otherwise indicated to be lost or stolen, a malicious user (e.g., other than the subscriber) may not access sensitive data or information saved on such a mobile device. In other words, by using the messaging service engine, the message service provider may transmit a message remotely to remove or deny access to available data on the mobile device for an unintended use. By sending the message, using a service message service (SMS) message, instant message or an e-mail to the mobile device with an instruction, the messaging service engine may automatically destruct or irrecoverably delete the data. For example, sensitive data from a lost or stolen mobile device may be remotely deleted. Instead of blocking connectivity of a mobile device which may be stolen or lost to a network, by denying access to data available on a mobile device which may be stolen or lost, at least a portion such vulnerable data stored on the mobile device also becomes inaccessible for malicious usage.

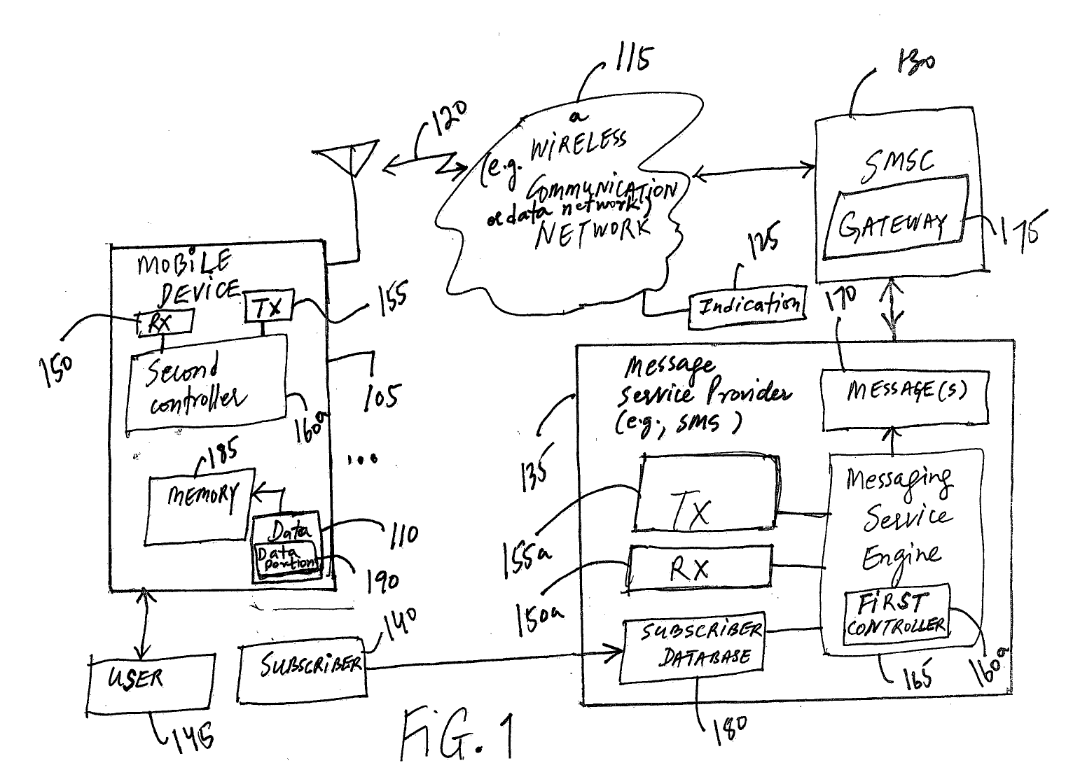

Referring to FIG. 1, communications system 100 is illustrated to include a mobile device 105 in the event the mobile device 105 is lost or stolen may enable a wireless communication 120 over the network 115 for the mobile device 105. Instead of the network 115, the mobile device 105 may control, for example, deny access to data 110 stored on the mobile device 105, according to one embodiment of the present invention. Data 110 may comprise a data portion 110a, which may indicate an identification number for the mobile device 105, such as cell I.D.

For the purposes of blocking connectivity to a network 115, when the mobile device 105 may be lost or stolen, the mobile device 105 may receive an instruction remotely to deny access to the data 110 for an unintended use. Examples of the unintended use include accessing sensitive data or information from the data 110, using, for example, address book, calendar, e-mail, and the like information for malicious purposes.

The mobile device 105 may store the data 110, which may be associated with an individual having a subscription to a service. For example, the mobile device 105 may store the data 110 based on a mobile network subscription from a network operator which may operate the network 115. The network 115 may include one or more telephone company networks, the Internet, other private networks, or the like.

The communications system 100, in one embodiment, may enable the mobile device 105 to communicate with the network 115 by exchanging one or more messages. Examples of the messages include a Short Message Service (SMS) message, an instant message, an e-mail, and the like. For example, the mobile device 105 may periodically transmit and receive one or more message(s) over the network 115 to enable a subscription of a wireless service. A SMS message is a text message service that enables short messages of generally no more than 140-160 characters in length to be transmitted and received, for example, from a cell phone using a two-way text messaging service offered on digital networks.

To forward a message to a desired recipient over the network 115, the mobile device 105 may include device information, such as an indication of network connectivity 125 to the network 115 within the wireless communication 120 for a particular network operator. Examples of the indication of network connectivity 125 include a telephone call or an instant message, an e-mail associated with the network 115.

In one embodiment, the communications system 100 may comprise a short message service center (SMSC) 130 to forward the wireless communication 120 to a message service provider 135. The SMSC 130 may provide a number of services, including regulating the transfer of messages between the mobile device 105 and the message service provider 135. Consistent with one embodiment, the SMSC 130 may deliver cellular or mobile Short Message Service (SMS) messages to an intended recipient, such as to the message service provider 135 or another mobile device user.

In operation, the SMSC 130 may forward a SMS message to the intended recipient. The SMSC 130 provides a number of services, including regulating the transfer of messages between mobile devices. When the message service provider 135 or another mobile device user sends a SMS message to a recipient, the SMS message is sent to the SMSC 130. The SMSC 130 stores the message and then delivers it to the intended recipient when they are available. The SMSC 130 also keeps track of any charges that are incurred. Generally, there is at least one Short Message Service Centre (SMSC) per network. For bulk transmission and reception of SMS messages, SMSCs have conventional, fixed, network interfaces as well as mobile network interfaces. A number of protocols have been defined to support this sort of wire-line access. Short Message Peer to Peer (SMPP) protocol is an open industry standard messaging protocol designed to simplify integration of data applications with wireless mobile networks such as GSM, TDMA, CDMA and PDC. The protocol is widely deployed in the mobile telecommunications industry. Other suitable communication including e-mails, instant messaging and conventional telephone calls may be used instead of an SMS message to transmit the indication of network connectivity 125.

Using the SMSC 130, the message service provider 135 may receive the indication of network connectivity 125 from the network 115. In one embodiment, the mobile device 105 may generate the indication of network connectivity 125 to the network 115 for indicating the status of device connectivity. Alternatively, the network 115 may form the indication of network connectivity 125 for the message service provider 135 upon determining that the mobile device 105 is either stolen or lost by the subscriber 140 of the mobile device 105. For example, a network operator may use the message service provider 135 to communicate with the mobile device 105 to determine whether the connectivity of the mobile device 105 over the network 115 is available to the subscriber 140. If the network 115 is unable to establish a desired communication for an authenticated user, the message service provider 135 may indicate that the mobile device 105 is associated with a user 145 unknown to the network 115.

Persons of ordinary skills in the art should appreciate that portions of the communications system 100, including the mobile device 105, the network 115, the SMSC 130 may be suitably implemented in any number of ways to include other components using hardware, software or a combination thereof. Wireless communication systems are known to persons of ordinary skill in the art and so, in the interest of clarity, only those aspects of the communications system 100 that are relevant to the present invention will be described herein. In other words, unnecessary details not needed for a proper understanding of the present invention are omitted to avoid obscuring the present invention.

In the communications system 100, messages, such as text, voice, image information or other data may be transmitted over an air interface between a pair of transmitting and receiving radio stations (e.g., a base station or a mobile unit, terminal, or station, respectively) within a frequency range. As one example, a Global System for Mobile Communication (GSM) system may use a frequency range of 900, 1800 or 1900 MHz. Likewise, a Universal Mobile Telecommunication System (UMTS) may use 2000 MHz. Other networks such as Code Division Multiple Access (CDMA) or GPRS may use a particular frequency range to transmit and receive messages over a wired or wireless LAN.

Examples of the wireless network 115 include a Third Generation (3G) network based on a UMTS protocol, although it should be understood that the present invention may be applicable to other systems or protocols that support multi-media, data, optical, and/or voice communication. For instance, protocols like CDMA and General Packet Radio Service (GPRS) for GSM networks may be used. That is, it should be understood, however, that the configuration of the communications system 100 of FIG. 1 is exemplary in nature, and that fewer or additional components may be employed in other embodiments of the communications system 100 without departing from the spirit and scope of the instant invention.

According to one embodiment, the wireless network 115 may comprise one or more data networks, such an Internet Protocol (IP) network comprising the Internet and a public telephone system (PSTN). Over the wireless connection 120, for example, the subscriber 140 may communicate high-speed multimedia information including voice, data, and video content. The mobile device 105 may take the form of any of a variety of devices, such as mobile terminals including cellular phones, personal digital assistants (PDAs), laptop computers, digital pagers, wireless cards, and any other device capable of accessing the wireless network 115.

Consistent with one embodiment of the present invention, the mobile device 105 may comprise a receiver 150 and a transmitter 155 to communicate with the network 115. Likewise, the message service provider 135 may comprise a messaging service engine 165 coupled to a receiver 150a and a transmitter 155a to communicate with the SMSC 130. The messaging service engine 165 may further comprise a first controller 160 and the mobile device 105 may further comprise a second controller 160a. The first controller 160 may provide one or more message(s) 170 for the second controller 160a to instruct the mobile device 105 to deny access to the data 110. Examples of the message(s) 170 include a SMS message, a text message, an instant message, an e-mail, and the like.

Some operators may use short message service (SMS) messages via a cellular network to supply the subscriber 140 with a one-time password or token (“access token”). To initiate an authentication process, the user 145 first sends a SMS message to a network operator or a service provider, possibly including the identification of the mobile device 105. The user 145 may receive a SMS message with an access token, if the user 145 is the subscriber 140, which needs to be submitted the wireless network 115.

In operation, the messaging service engine 165 may receive the indication of network connectivity 125 to the network 115 for the mobile device 105 from the SMSC 130. In response to the indication of network connectivity 125, the messaging service engine 165 may generate the message(s) 170.

According to one embodiment of the present invention, the SMSC 130 may comprise a SMS gateway 175 that is generally responsible for forwarding the message(s) 170 to the intended recipient, such as the mobile device 105. The SMS gateway 175 may forward the message(s) 170 through any of a variety of routes over the network 115. The SMS gateway 175 of the SMSC 130 may include hardware, software, or a combination thereof to forward the message(s) 170 to a desired caller or sender.

By using SMS messages in a mobile environment, e.g., via a General Packet Radio Service (GPRS) for GSM networks, the second controller 160a may send and receive SMS messages. A SMS message may be transmitted and received, for example, from a cell phone using a two-way text messaging service offered on digital networks via the SMSC 130 of a network operator or from the Internet, using the SMS gateway 175.

The network 115 may use the data portion 110a to determine location of the mobile device 105 for the message service provider 135. In some embodiments of the present invention, the messaging service engine 165 may retrieve the data portion 110a from the mobile device 105 before blocking connectivity to the network 115.

In accordance with one embodiment of the present invention, the message service provider 135 may include a listing or database of subscribers 180. For example, the subscriber database 180 may identify those subscribers, such as the subscriber 140 having permission to access the data 110 stored in memory 185 on the mobile device 105.

The messaging service engine 165 may identify the user 145 as the subscriber 140 of the mobile device 105 based on any of a variety of unique identifiers. For example, the telephone number of the mobile device 105 may be included. Alternatively, an e-mail address associated with the subscriber 140 may be included with the wireless communication 120. In this way, the indication of network connectivity 125 to the network 115 for the mobile device 105 may use some unique identifying indicia associated with subscriber 140. The unique identifying indicia may be compared against a list or database of the subscribers, such as the subscriber database 180 to determine whether the user 145 is the subscriber 140, in response to the indication of network connectivity 125.

Those skilled in the art will appreciate that the subscriber database 180 may be formed using information collected during a registration process. The indication of network connectivity 125 may be determined or generated by any of a variety of unique events. For example, the subscriber 140 may provide a first event that indicates that the mobile device 105 is either stolen or lost. Alternatively, the subscriber 140 may send an e-mail or an instant message or a short message service (SMS) message over the network 115.

Other events, such as use of a wrong user I.D. and/or password exceeding a predetermined limit of number of attempts may indicate to the network 115 that the mobile device 105 may be lost or stolen. In any event, the indication of network connectivity 125 may indicate that the mobile device 105 has lost connectivity to the network 115 for the subscriber 140. Thus, the data 110 stored in the memory 185 at the mobile device 105 may be vulnerable to a malicious use. The user 145 may not be the subscriber 140 who is authorized to use by virtue of having a subscription to a service for the mobile device 105 and may access the data 110 for an unintended use. Accordingly, the mobile device 105 may deny access or delete at least a portion 110a of the data 110 stored in memory 185.

The wireless network 115 may use base stations for establishing a communication link with the mobile device 105, such as for cellular WANs, for example. An access point may support the provisioning of multiple virtual networks, identified by a service set identifier (SSID), which is a unique label that distinguishes one WLAN from another.

The authentication process may involve sending a request message from the mobile device 105, and in turn, receiving a reply message, such as the message(s) 170 over the wireless connection 120. An example of the request message and message(s) 170 include SMS messages. Of course, other forms of signaling messages capable of interactive transmission on a wireless medium, such as air interface are within the scope of the present invention, as persons of an ordinary skill in the art will recognize, such signaling messages may enable exchange of information between the mobile device 10 and the wireless network 115 in the communications system 100. The message service provider 135 may use the wireless network 115 to establish, monitor, and/or release the wireless connection 120.

The SMSC 130 may comprise instructions, such as a software program or a firmware that the wireless network 115 may execute for providing network authentication. To authenticate access of the user 145 within the communications system 100, the second controller 160a and the first controller 160 may cooperatively use the SMSC 130.

Upon entering a coverage area of the wireless network 115, for example, request and reply messages may be exchanged between the first controller 140 and the second controller 160a through the SMSC 130, in some embodiments. The mobile device 105 may indicate an authentication event to the wireless network 115. The authentication event may be generated when a user desires access to the wireless network 115 and/or the mobile device 105 interacts with the SMSC 130 for accessing the wireless network 115.

In response to the authentication event, the second controller 160a may interact with the first controller 160 of the message service provider 135 to allow the subscriber 140 to connect to the wireless network 115. In this manner, the user 145, at the mobile device 115 may authenticate itself to the wireless network 115.

A user may subscribe to a wireless service, to become an authorized user of the mobile device 105. That is, the authorized user may receive a subscription from the message service provider 135 to use the wireless network 115. To this end, the message service provider 135 may cause the wireless network 115 control access to data 110 associated with the subscriber 140 when enabling a wireless service.

In the authentication process, the mobile device 105 may communicate with the message service provider 135 associated with an operator of the wireless network 115 to authenticate the user 140. That is, for the purposes of network authentication, the mobile device 105 may communicate with the SMSC 130 associated with an operator, i.e., a network operator/service provider. Based on the password, the messaging service engine 165 may enable the user 140 to login into the wireless network 115.

The communications system 100 may use an authentication process which involves sending and receiving SMS messages to determine access to the data 110. In this way, according to some embodiments of the present invention, the user 140 may not avoid user authentication when using a wireless service.

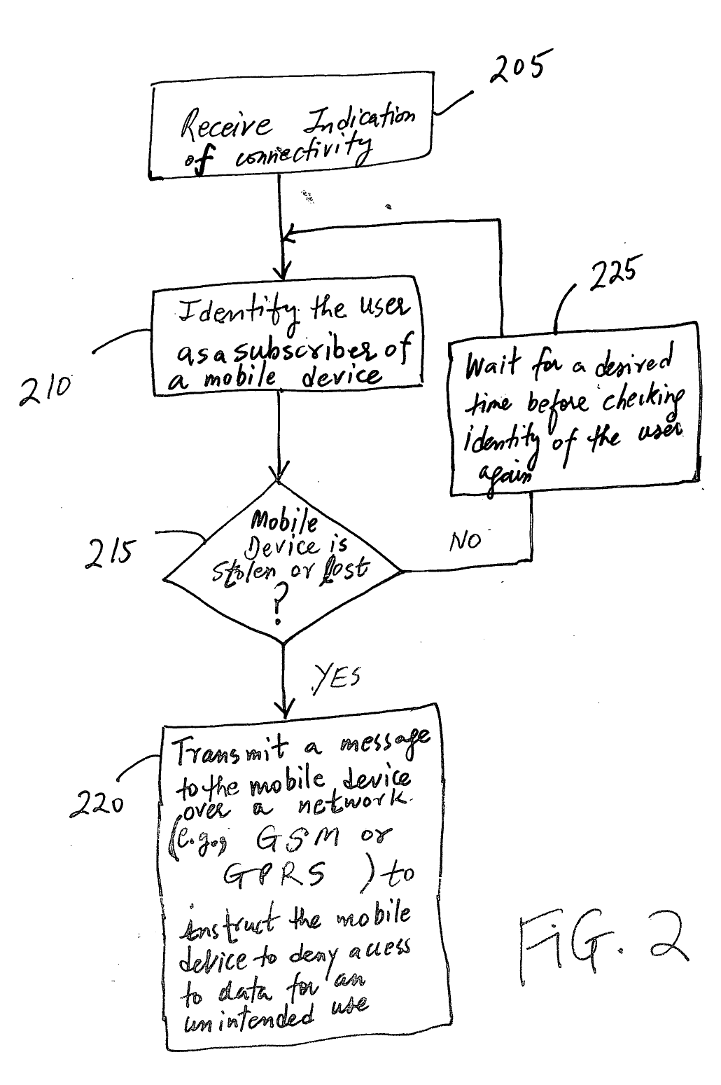

Turning now to FIG. 2, a stylized representation for implementation a method for remotely controlling access to a subscriber data over a network for a mobile device using messaging is provided. The mobile device 105 may deny access or delete at least a portion 110a of the data 110 stored in memory 185. At block 210, the messaging service engine 165 may identify the user 145 as the subscriber 140 of the mobile device 105, in response to the indication of network connectivity 125. That is, based on the indication of connectivity 125 associated with the subscriber 140, the messaging service engine 165 may determine whether the user 145 of the mobile device 105 is the subscriber 140.

To determine whether the mobile device 105 is stolen or lost based on the indication of connectivity 125, the messaging service engine 165 may compare information associated with the user 145 and the subscriber 140 maintained in the subscriber database 180. Accordingly, a decision block 215 determines whether the mobile device 105 is stolen or lost.

If the mobile device 105 is determined to be stolen or lost, the messaging service engine 165 may transmit the message(s) 170 to the mobile device 105 over the network 115. For example, the message service provider 135 may use the transmitter 155a to send the message to the mobile device 105. The SMS gateway 175 associated with the SMSC 130 may forward the message(s) 170 to an appropriate mobile device 105 over the network 115. In this way, the mobile device 105 may receive one or more instructions within the message 170, instructing the mobile device to either, deny access to the data 110 for an unintended use and/or delete, as shown in block 220.

When the decision block 215 determines that the mobile device 105 is not stolen or lost, the messaging service engine 165 may wait for a desired time before checking the indentity of the user 145 again, as illustrated in block 225. Alternatively, the mobile device 105 may periodically check the identity of the user 145 based on a criterion. For example, based on the criterion, the mobile device 105 may determine itself whether something is amiss or unusual activity by communicating with a peer device to periodically verify the identity of the subscriber 140.

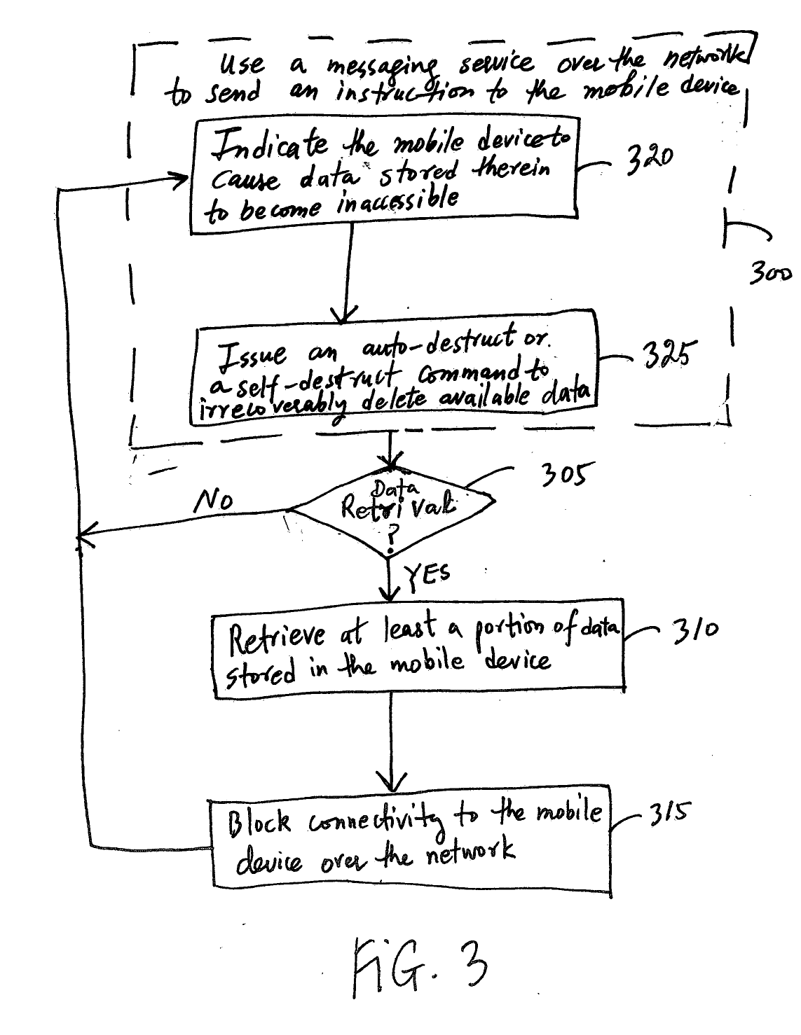

Referring to FIG. 3, a stylized representation for implementing a method of providing instruction(s) to the mobile device 105 by the messaging service engine 165 is shown in accordance with one embodiment of the present invention. In one embodiment, by using a messaging service, such as a SMS message service based on the SMSC 130, at block 300, the transmitter 150a may send the message 170. The message(s) 170 may include an instruction to delete the data 110. To send the message(s) 170 to a targeted device, such as the mobile device 105, information associated with the subscriber 140 may be used.

According to one embodiment, at a decision block 305, the second controller 160a at the mobile device 105 may determine whether retrieval of the data 110 or the data portion 110a is indicated in the message(s) 170. In other words, the second controller 160a may analyze the instruction(s) associated with the message 170 for a request for data retrieval of at least the data portion 110a stored in the memory 185 at the mobile device 105. If such a request is indicated by the instruction(s), the second controller 160a, at block 310, may retrieve the data portion 110a for sending back to the message service provider 135. At block 315, the instruction(s) may cause the mobile device 105 to block connectivity over the network 115.

One embodiment of the method of using a messaging service by the messaging service engine 165, as shown in block 300, may include the instruction(s) to the mobile device 105 for causing the data 110 stored therein to become inaccessible, as shown in block 320.

In one embodiment, the second controller 160a may issue a command based on the instruction associated with the message(s) 170, to irrecoverably delete desired data including the data 110 to the mobile device 105. Examples of the command include an auto-destruct or a self-destruct command, as shown in block 325. Accordingly, in some instances, it may,be useful to bypass blocks 320, 325 and retrieve a desired data portion 110a of the data 110, as indicated in block 310. For example, in such instances, the messaging service engine 165 may retrieve device identification (I.D.) for the mobile device 105 prior to instructing the mobile device 105 to delete the data 110 or blocking connectivity thereof to the network 115.

However, in other instances, if retrieval of the data 110 stored in the mobile device 105 is not indicated, the messaging service engine 165 may instruct the mobile device 105 to delete the data 110, for example, in a way that recovery or access to available data is denied for an unintended use by the user 145 who is not identified to be the subscriber 140 of a lost or stolen mobile device.

An authentication process of the user 145 by the communications system 100 may cause the mobile device 105 to exchange messages, such as SMS messages with the wireless network 115, such as a wide area network (WAN). In one embodiment, General Packet Radio Service (GRPS) for a Global System for Mobile Communications (GSM) network may be used to send a request message to the wireless network 115 upon an indication of login onto a Wi-Fi network. That is, a GSM/GPRS data connection may be used for exchanging Internet Protocol (IP) data packets.

The wireless network 115 may include a multiplicity of access points that supports the Wi-Fi network. In this manner, signaling messages may be exchanged between the mobile device 105 and the wireless network 115 over a wireless connection 120. To provide a wireless service to an authorized user, the mobile device 105 may automatically authenticate the subscriber 140 to the Wi-Fi network. An access point (AP) may be associated with the Wi-Fi network to provide access to data networks, such the Internet.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of wireless communication over a network with a mobile device having access to data associated with a subscriber, the method comprising:
in response to an indication of connectivity to said network for said subscriber, transmitting at least one message to said mobile device over said network for instructing said mobile device to deny access to said data for an unintended use.

2. A method, as set forth in claim 1, wherein transmitting said at least one message to said mobile device further comprises:
determining whether a user of said mobile device is said subscriber who is associated with said mobile device based on said indication of connectivity to said network for said subscriber; and
if said user of said mobile device is determined not to be said subscriber, causing said at least one message to remotely delete said data from said mobile device.

3. A method, as set forth in claim 2, wherein determining whether a user of said mobile device is a subscriber further comprises:
receiving said indication of connectivity to said network for said subscriber.

4. A method, as set forth in claim 3, further comprising:
determining whether said mobile device is at least one of stolen or lost based on said indication of connectivity to said network for said subscriber; and
if said mobile device is determined to be said at least one of stolen or lost, instructing said mobile device to remove said data from said mobile device.

5. A method, as set forth in claim 1, wherein transmitting at least one message to said mobile device over said network further comprises:
indicating said mobile device to cause said data inaccessible for unintended use.

6. A method, as set forth in claim 5, wherein indicating said mobile device to cause said data inaccessible further comprises:
instructing said mobile device to irrecoverably delete said data.

7. A method, as set forth in claim 6, wherein instructing said mobile device to irrecoverably delete said data further comprises:
issuing at least one of an auto-destruct or a self-destruct command to instruct said mobile device to irrecoverably delete desired data at said mobile device.

8. A method, as set forth in claim 1, wherein transmitting at least one message to said mobile device over said network further comprises:
retrieving at least a portion of said data from said mobile device over said network.

9. A method, as set forth in claim 8, further comprising:
retrieving at least said portion of said data from said mobile device before blocking connectivity to said mobile device over said network.

10. A method, as set forth in claim 1, wherein transmitting at least one message to said mobile device over said network further comprises:
using a short messaging service over said network to send an instruction to said mobile device.

11. A communications system for wireless communication over a network with a mobile device having access to data associated with a subscriber, the wireless communication system comprising:
a receiver to receive an indication of connectivity to said network for said subscriber associated with said mobile device;
a messaging service engine coupled to said receiver to provide at least one message for said mobile device to instruct said mobile device to deny access to said data associated with said subscriber for an unintended use in response to said indication of connectivity; and
a transmitter coupled to said messaging service engine to send said at least one message to said mobile device over said network.

12. A communications system, as set forth in claim 11, wherein said messaging service engine comprises:
a first controller for determining whether a user of said mobile device is said subscriber who is associated with said mobile device based on said indication of connectivity and causing said at least one message to remotely delete said data from said mobile device if said user of said mobile device is determined not to be said subscriber.

13. A communications system, as set forth in claim 12, wherein said mobile device comprising:
a second controller to cause said mobile device to make said data inaccessible for said unintended use.

14. A communications system, as set forth in claim 13, wherein said first controller to retrieve at least a portion of said data from said mobile device over said network before blocking connectivity to said mobile device over said network.

15. A communications system, as set forth in claim 12, wherein said first controller to use a short messaging service over said network to send an instruction to said mobile device.

16. A mobile device, comprising:
a receiver to receive at least one message over a network; and
a controller coupled to said receiver for instructing said mobile device to deny access to data associated with a subscriber for an unintended use in response to an indication of connectivity to said network for said subscriber.

17. A mobile device, as set forth in claim 16, further comprises:
a transmitter for transmitting at least a portion of said data from said mobile device over said network before blocking connectivity to said mobile device over said network.

18. A mobile device, as set forth in claim 16, wherein said controller to use a short messaging service over said network to receive an instruction at said mobile device and indicate said data to be inaccessible for said unintended use.

19. A messaging service engine, comprising:
a controller adapted to transmit at least one message to a mobile device over a network to instruct said mobile device to deny access to data associated with a subscriber for an unintended use in response to an indication of connectivity to said network for said subscriber.

20. A method of wireless communication over a network for a mobile device having access to data associated with a subscriber, the method comprising:
receiving at least one message at said mobile device over said network to instruct said mobile device to deny access to said data associated with said subscriber for an unintended use in response to an indication of connectivity to said network for said subscriber.
